(19) United States
(12) Patent Application Publication
(10) Pub. No.: US 2026/0120545 A1
(43) Pub. Date: Apr. 30, 2026

(54) Clock Management System for n-Player Games

(71) Applicant: Christopher Allen Perkins, Nashua, NH (US)

(72) Inventor: Christopher Allen Perkins, Nashua, NH (US)

(21) Appl. No.: 18/385,542

(22) Filed: Oct. 31, 2023

(51) Int. Cl. G07F 17/32

(52) U.S. Cl. CPC G07F 17/3269; G07F 17/3239

(57) ABSTRACT

This novel centralized and/or distributed approach to game clock management, which utilizes co-management of one or more individual and/or cooperative game-clocks and/or other (possibly heterogeneous) game management clocks to enforce temporal gaming rules for game-players, game-administrators, and/or other game-stakeholders, utilizes temporal monitoring of various aspects of the game by providing individual and/or team game-player clocks as well as sub-environment and/or environment-wide clocks, including concurrent and/or synchronized, distributed and/or centralized, and/or continuous and/or discrete clocks, as needed. Individual game-player clocks, and/or team game-player clocks, either centralized or distributed, such as a real-time clock, are managed to allow the stakeholders ways to enforce game rule integrity. This clock-management system may be available to all game stakeholders and/or may be limited by game rules to a subset thereof.

### FIELD OF THE INVENTION

The disclosure relates generally to clock management systems for card games, board games, games of chance (gambling), computer games, sports, and other types of games played on any type of format/platform (physical, computer, etc.).

### SCOPE

We believe the group closes to our embodiments is G 18 F 22/00. The following other areas lie within a broader scope of this invention:
Clock Management
Chess-Clock
Game Clock
Game Management
Wagering Games
Games of Chance

### CROSS REFERENCE TO RELATED APPLICATIONS

AU2004260994B2
AU2009200455B2
CA2498814C
EP1521421A2
U.S. Pat. No. 7,201,661
U.S. Pat. No. 7,347,780
U.S. Pat. No. 7,384,339
U.S. Pat. No. 7,445,549
U.S. Pat. No. 7,566,274
U.S. Pat. No. 7,753,790
U.S. Pat. No. 7,972,209
U.S. Pat. No. 8,460,103
U.S. Pat. No. 10,272,330
US20090143141A1
US20140073401A1
U.S. Pat. No. 8,417,258
U.S. Pat. No. 8,873,589
U.S. Pat. No. 9,754,447
U.S. Pat. No. 10,162,379
U.S. Pat. No. 10,272,328
U.S. Pat. No. 10,587,700
U.S. Pat. No. 10,630,501
U.S. Pat. No. 11,258,654
US20040266533A1
U.S. Pat. No. 7,985,132

### BACKGROUND

In this invention, time is viewed as a resource co-managed by game-stakeholders, which may include game-players (individuals and/or teams), game-administrators, game-spectators, and/or any other gaming roles. Each game-stakeholder (with the exception of game-spectators) may have one or more individual clocks (associated with only one game-player) together with access to one or more shared clocks (associated with zero or more game-players). Game-stakeholder clocks provide a mechanism for managing the available time for game-stakeholder actions that are temporally limited. Game-stakeholder clocks may persist across gaming environments, such as casino gaming rooms in the preferred embodiment, or sub-environments, such as casino gaming tables in the preferred embodiment. These game-stakeholder clocks, working together under the clock management system, maintain the integrity of the game structure based on any or all relevant external gaming rules.

For this invention, “game” refers to any activity, such as card games, board games, games of chance (with or without wagering), computer games, sports, and other types of activities, governed by a set of rules and involving one or more players, along with any other game-specific elements. Game-stakeholder clocks are linked to a single game or set of games. A game may have a pre-determined start time, and/or be started at the discretion of any game-administrator. A game may have a pre-determined end date/time, be marked ‘ended’ at the discretion of the relevant game-stakeholders, or continue indefinitely. Game-stakeholder clocks may or may not persist through the end of the game or beyond.

For this invention, a “user” of the clock management system refers to any individual and/or group of individuals utilizing an implementation of this invention (e.g. software). A user may fall into any number of game-stakeholder categories at any given point in time.

This invention describes a framework for clock management of an administered or non-administered n-player game or games, whereby each player may be provided with their own individual clock and/or shared clocks. In the preferred embodiment, the game is tournament poker, which is viewed herein as an administered n-player game.

### SUMMARY

In this invention, time is viewed as a resource co-managed by game-stakeholders, which may include game-players (individuals and/or teams), game-administrators, game-spectators, and/or any other gaming roles. Game-stakeholder clocks provide a mechanism for managing the available time for game-stakeholder actions that are temporally limited. Game-stakeholder clocks, working together under the clock management system, maintain the integrity of the game structure based on any or all relevant external gaming rules. “Game” refers to any activity, such as card games, board games, games of chance (with or without wagering), computer games, sports, and other types of activities. In the preferred embodiment, the game is tournament poker, which is viewed herein as an administered n-player game.

### BRIEF DESCRIPTION OF THE DRAWINGS

Example diagrams throughout use the example of tournament poker, the preferred embodiment, for illustrative purposes only.

FIG. 1 depicts an example of a web-based graphical user interface (GUI) associated with a software program which allows a game-stakeholder to enter a sub-environment, which in the case of the preferred embodiment (an administered n-player game) is a poker table.

FIG. 2 depicts an example of a web-based GUI associated with a software program which allows a game-stakeholder to view a sub-environment, which in the case of the preferred embodiment (an administered n-player game) is a poker table.

FIG. 3 depicts an example of a web-based GUI associated with a software program which allows a game-administrator to manage (start, stop, add, remove, etc.) each game-player's clock(s), as well as any shared clocks, in a sub-environment, which in the case of the preferred embodiment (an administered n-player game) is a poker table.

FIG. 4 depicts an example of an Android application GUI associated with a software program which allows a game-stakeholder to view a sub-environment, which in the case of the preferred embodiment (an administered n-player game) is a poker table.

FIG. 5 depicts a UML diagram displaying a software architecture between the key objects that may be utilized by a software implementation of the preferred embodiment.

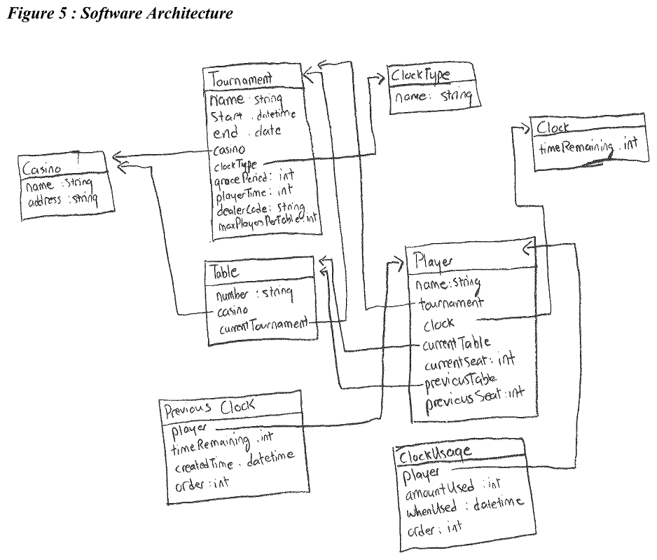

FIG. 6 depicts a hierarchical structure that timing data may be stored in for a software implementation of the preferred embodiment.

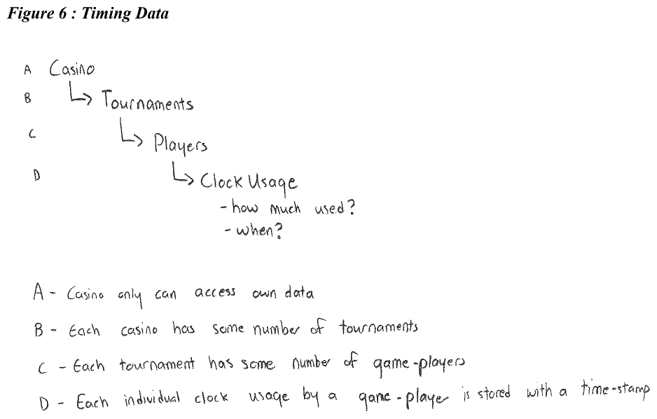

FIG. 7 depicts two tables displaying individual player timing data that could be used to provide data analysis for a game-administrator to improve the structure of their game by better understanding when players utilize their time, and how much time is used.

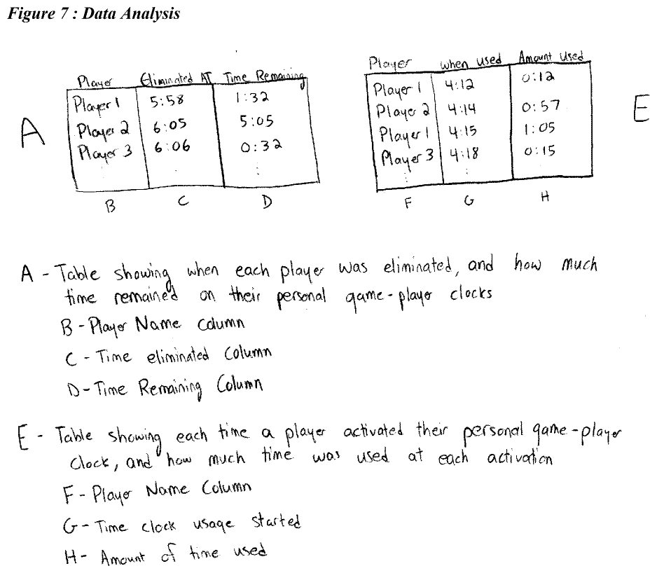

FIG. 8 depicts an example of a client-server implementation of the preferred embodiment, where some number of clients view and interact with game-player clocks while the server(s) handle the various requests from those clients.

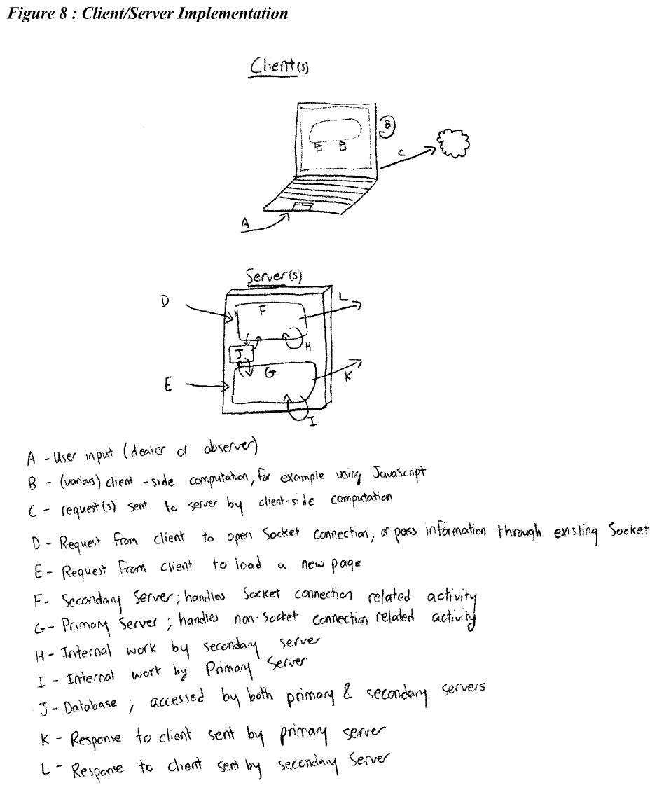

FIG. 9 depicts an example of an input/output pathway from various clients through the server and the returning output to each of the clients.

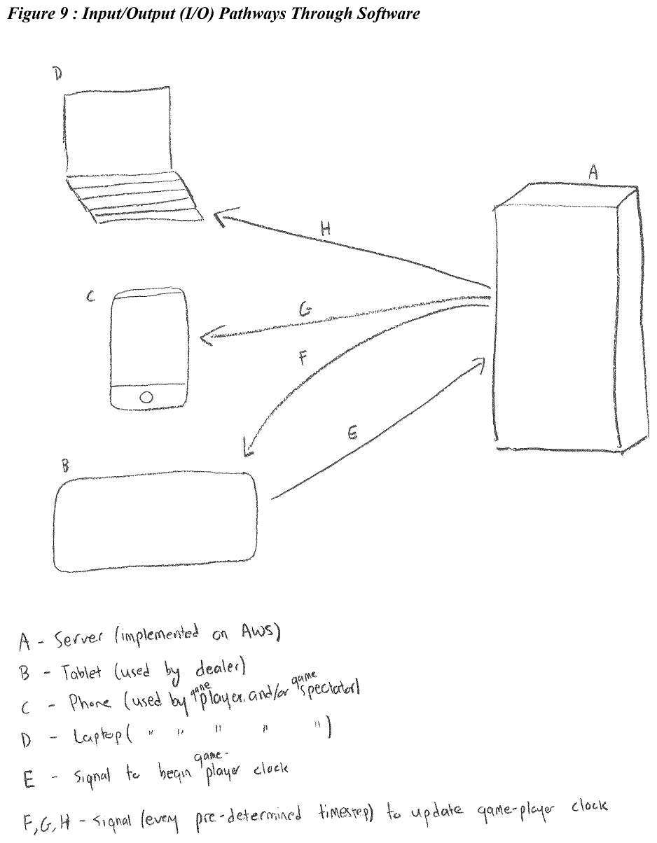

### DETAILED DESCRIPTION

In the preferred embodiment of the administered, n-player game of tournament poker, each game player has an accompanying (exclusive) individual clock which is managed by the game-administrator(s). It will be apparent to those skilled in the art that modifications and variations can be made in the present invention (beyond tournament poker) without departing from the scope or spirit thereof. For instance, features illustrated or described as part of one embodiment may be used on another embodiment to yield a still further embodiment. Thus, it is intended that the present invention covers such modifications and variations.

A gaming implementation utilizing this clock management system may or may not include visual computer interfaces representative of the game, which may or may not require user interaction.

In the preferred embodiment (an administered n-player game), each game-player is associated with their own individual game-player clock which possesses features such as timing controls for management of temporally monitored activities. For example, when a game-player or game-administrator desires time to take an action or make a decision, their clock may be activated either automatically or manually by the game-player, game-administrator, and/or any other game-stakeholder, and that same (or different) entity may stop the given game-player's clock once the game-player has completed their action or decision (i.e. once they have completed the timed task).

Games may utilize any number of (possibly heterogeneous) managed clock types, which game-administrators may choose between. Each given clock type may support continuous-time and/or discrete-time (utilizes pre-set temporal increments). For example, in an administered n-player game, a game-administrator may choose to utilize any number of continuous-time and/or discrete-time clocks.

Some game formats and/or rules may allow players to transit between gaming environments and/or sub-environments. During a transition, the game-player may or may not be actively involved in the game. This invention provides a mechanism for retaining information (either fully or partially) associated with an individual's game-player clock during the transition. The transition, either in whole or part, may be managed by the game-player, a game-administrator, and/or other game-stakeholders. In the preferred embodiment (an administered n-player game), the environment may be a poker tournament or set of poker cash games, while a sub-environment may be a single poker table. An example of a transition is a player being transferred to a new table during a tournament.

Individual game-player clocks may or may not utilize a customizable, dynamic grace period, whereby a game-player is given that grace period of time before their individual game-player clock begins to be utilized. Upon expiration of the grace period, their individual game-player clock begins. Activation of an individual game-player clock may or may not occur automatically upon expiration of this grace period. This grace period may serve to increase the speed of game-player actions, which may increase the popularity of the game, and/or segment the game to better facilitate scheduled interruptions, such as commercials.

Time intervals, including timing thresholds, that are utilized by game-player clocks may also be customizable and/or dynamic (i.e., adjusts based on any number of factors); for example, providing for random and/or earned bonus times.

Game clocks may be implemented using either a centralized or distributed clock management system, or a combination of both, which may vary across game environments and/or sub-environments. This novel clock management system handles any and all actions that may be performed on a game-player's clock.

The clock management system supports any number of individual game-player clocks and/or shared game-stakeholder clocks to be running either independently or dependently, synchronously or asynchronously, at any given point in time.

The fundamental unit of time utilized by the clock management system may very across game-stakeholder clocks, game-formats, and/or game environments and/or sub-environments. For example, a game-player clock may utilize seconds as its fundamental unit of time while the supporting computer clock may utilize micro seconds as its fundamental unit of time. Roundoff errors may be handled by any consistent rounding scheme. In the preferred embodiment, a floor rounding scheme is utilized.

The clock management system supports games ending at a pre-determined date/time, ending at the discretion of the relevant game-stakeholders, extending time limits when the game's rules allow, and/or continuing indefinitely with no pre-determined end date/time.

The clock management system supports game-stakeholder clocks, such as individual game-player clocks and/or game-stakeholder clocks that are associated with zero or more game-players and/or game-stakeholders.

Each game-stakeholder clock may be associated with an individual game or a set of games managed by the clock management system.

The clock management system supports adding and/or removing time from game-stakeholder clocks based on pre-determined, game-specific conditions. For example, in the preferred embodiment (an administered n-player game), a game-player's clock may be increased due to winning a hand of poker or as a reward for quicker than average decision making at previous game-player decision points.

A game may include game-player transition clocks, which denote temporal restrictions on how game-players enter a transition period between sub-environments, how long a game-player may remain in a transition period, and/or when a game-player may exit a transition period. For example, in the preferred embodiment (an administered n-player game), a game-player might only be granted 2 minutes to move from one table to their next assigned table, and taking longer may prompt the dealer at the new table (a game-administrator) to enforce a penalty upon that game-player, such as being required to sit out a set number of hands or a set number of orbits of play dependent upon how much extra time the given game-player took to voluntarily exit the transition period.

A game may allow for game-player breaks, which may denote temporal restrictions on how game-players may pause their involvement in an environment and/or sub-environment while the game continues, and subsequently re-enter that environment and/or sub-environment.

A user of the clock management system may alter their game-stakeholder role(s) at various stages of a game. Each game-stakeholder role may require authentication specific to the game and/or requirements, which may be set by the game-administrator(s). For example, in the preferred embodiment (an administered n-player game), a user may authenticate their role as a poker dealer (a game-administrator) by entering a private pass key provided by their supervisor (also a game-administrator), who in turn either received that pass key from the clock management system or provided that pass key to the clock management system. A properly authenticated poker dealer may then control game-player clocks as-needed for their given table. The private pass key may be associated with a unique identifier and/or may be a generic key used by zero or more game administrators.

A game-administrator may perform any number of actions on any or all of the individual game-player clocks, or any other clocks supported by the game. Clock actions may include, but are not limited to, adding time, resetting the time, and adjusting to a specific time.

A game-administrator may modify the set of game-players based on the given game rules by modifying the game-environment and/or any number of game sub-environments. Game rules may or may not be external to the clock management system.

Dependent upon the game rules, a game-stakeholder may be classified into one or more categories, such as (but not limited to): game-player, game-administrator, and game-spectator.

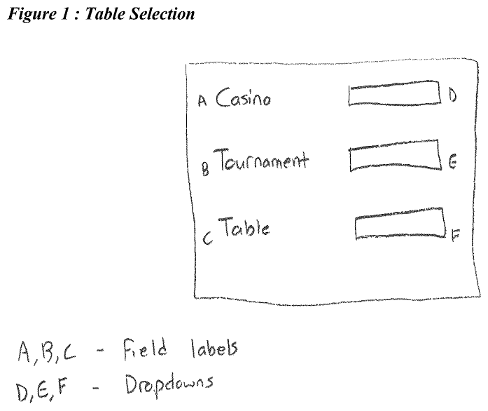

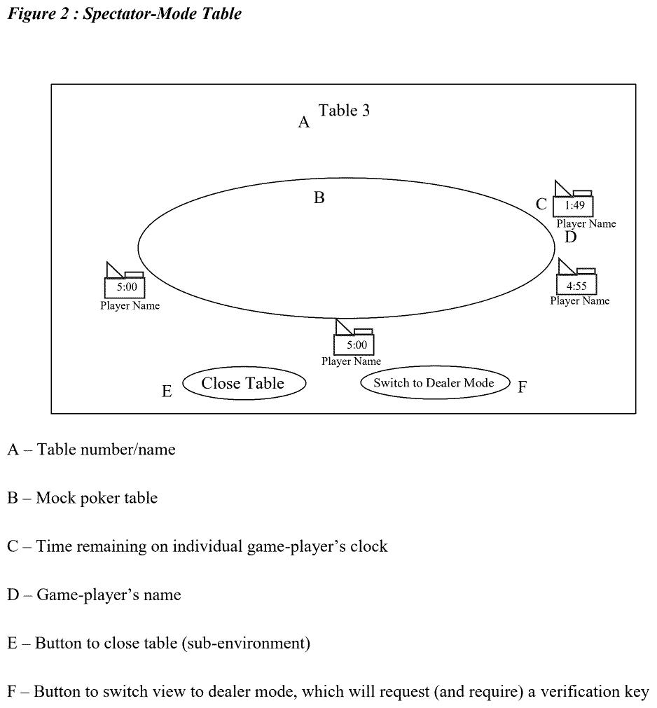

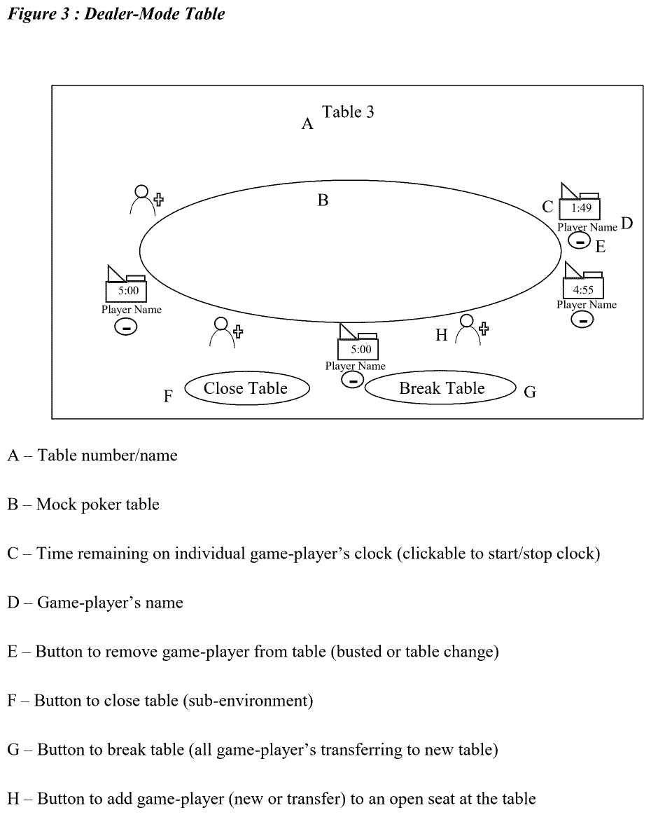

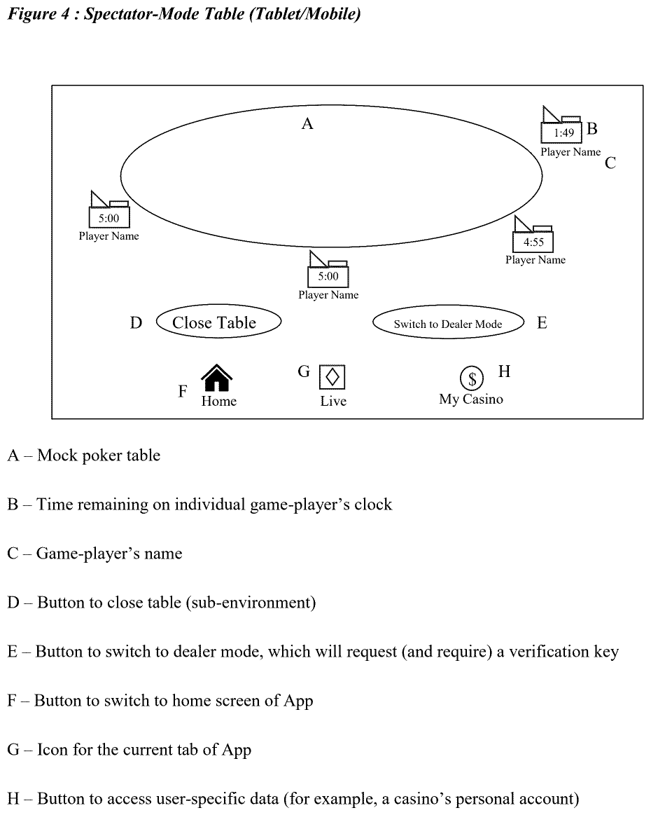

The preferred embodiment, as implemented via a website interface for varying screen sizes, orientations, browsers, and/or operating systems, is depicted in FIG. 1, FIG. 2, FIG. 3, & FIG. 4. This interface allows game-administrators to alter game-player clocks (as needed) and allows game-spectators (including game-players) to observe the clock values of each game-player. This embodiment logically extends to any browser, including but not limited to Chrome, Firefox, and Edge.

The preferred embodiment, as implemented via a mobile Android application, is depicted in FIG. 4. This embodiment logically extends to any mobile operating system application, including but not limited to Android & iOS.

The preferred embodiment, as implemented, utilizes several programming languages, including Java, JavaScript, PHP, HTML, CSS, and the Android Framework. This embodiment logically extends to any other programming languages, and is not limited to the existing implementation languages and/or language types.

The preferred embodiment, as implemented, utilizes a LAMP web-server (Linux, Apache, MySQL, & PHP) hosted by Amazon Web Services resources. This embodiment logically extends to any other web service platforms and/or hosting services and platforms.

Each game-player and/or game-team's clock usage data is logged throughout a game, storing all relevant clock management data. Each time a game-player and/or game-team's clock is utilized, the event is logged. This data may or may not be available for analysis, either in real-time, or subsequent to a game's termination. This data may or may not be logged anonymously.

At the conclusion of a game, the final status of each game-stakeholder clock may be retained with a reference to the individual game-stakeholders each clock belongs to, be retained without a reference to the individual game-stakeholders each clock belonged to, be logged with other game-stakeholder clock usage data for potential future analysis, predictions, promotions, and other such activities that analysis may support, and/or be discarded.

Each individual game-stakeholder clock may or may not be associated with a possibly unique identifier, assigned and managed by the clock management system. When present, this identifier persists while the player is participating in the game, including during transitions, and may or may not persist upon the stakeholder leaving the game or the game's conclusion. A trace of a game-player's clock activity may persist after they, or any other game-stakeholder, leave the game, even if their individual identifier has been removed. When present, this identifier may or may not be associated with any preexisting game-stakeholder identification.

Each game-player or game-team may be associated with one or more external accounts tracked by a game-administrator, may remain anonymous to the clock management system, and/or may have some personal information entered to associate their given game-player clock(s) with or without being associated with an external third-party account.

What is claimed is:

1. A clock-management system for an n-player game (or set of games), comprising:
a. Game-stakeholder clocks, including individual game-player clocks and game-stakeholder clocks that are associated with zero or more game-players and/or game-stakeholders;
b. A set of actions that may be performed by a game-administrator on any or all of the individual game-player clocks, or any other clocks supported by the game. Clock actions may include, but are not limited to, adding time, resetting the time, and adjusting to a specific time.
c. Any number of (possibly heterogeneous) managed clock types, which game-administrators may choose between. Each given clock type may support continuous-time and/or discrete-time (utilizes pre-set temporal increments);
d. Any number of individual game-player clocks and/or shared game-stakeholder clocks to be running either independently or dependently at any given point in time;
e. Games may end at a pre-determined date/time, end at the discretion of the relevant game-stakeholders, and/or continue indefinitely with no pre-determined end date/time;
f. Any or all necessary computer recourses, including but not limited to web servers, client interfaces, executable programs, and/or any other necessary resources;
g. Optional visual computer interface representations of the game, including but not limited to clock values, clock actions, and any or all game-specific information;

2. The clock management system of claim 1, wherein game-players may or may not be grouped into game-teams, such that:
a. Game-team clocks may be shared between one or more individual game-players;
b. Individual game-players on a game-team may additionally retain zero or more individual game-player clocks specific to their actions only.

3. The clock management system of claim 1, wherein individual game-player clocks may or may not utilize a customizable, dynamic grace period, whereby a game-player is given that grace period of time before their individual game-player clock begins to be utilized. Upon expiration of the grace period, their individual game-player clock begins. Activation of an individual game-player clock may or may not occur automatically upon expiration of this grace period.

4. The clock management system of claim 1, wherein game clocks may be implemented using either a centralized or distributed clock management system, or a combination of both, which may vary across game environments and/or sub-environments.

5. The clock management system of claim 1, wherein time may be added and/or removed from game-stakeholder clocks based on pre-determined, game-specific conditions.

6. The clock management system of claim 1, wherein game-player transition clocks may be included, which denote temporal restrictions on how game-players enter a transition period between sub-environments, how long a game-player may remain in a transition period, or when a game-player may exit a transition period. For example, in the preferred embodiment (an administered n-player game), a game-player may only be granted 2 minutes to move from one table to their next assigned table, and taking longer may prompt the dealer at the new table (a game-administrator) to enforce a penalty upon that game-player, such as being required to sit out a set number of hands or a set number of orbits of play dependent upon how much extra time the given game-player took to voluntarily exit the transition period. This invention provides a mechanism for retaining information (either fully or partially) associated with an individual's game-player clock while in transit.

7. The clock management system of claim 1, wherein game-player breaks may be included, which denote temporal restrictions on how game-players may pause their involvement in an environment and/or sub-environment while the game continues, and subsequently re-enter that environment and/or sub-environment.

8. The clock management system of claim 1, wherein time intervals, including timing thresholds, that are utilized by game-player clocks may also be customizable and/or dynamic (i.e., adjusts based on any number of factors); for example, providing for random and/or earned bonus times.

9. The clock management system of claim 1, wherein the fundamental unit of time utilized by the clock management system may very across game-stakeholder clocks, game-formats, and/or game environments and/or sub-environments.

10. The clock management system of claim 1, wherein a user may alter their game-stakeholder role(s) at various stages of a game. The addition of one or more game-stakeholder roles may require authentication specific to the game and/or requirements of the game-administrators.

11. The clock management system of claim 1, wherein a game-administrator may modify the set of game-players based on the given game rules by modifying the game-environment and/or any number of game sub-environments. Game rules may or may not be external to the clock management system.

12. The clock management system of claim 1, wherein game-stakeholder clocks may be suspended, re-activated, and/or terminated by a game-administrator based on any or all relevant external requirements.

13. The clock management system of claim 1, wherein clock usage data may or may not be logged, such that:
a. Each game-player and/or game-team's clock usage data may be logged throughout a game, storing all relevant clock management data. Each time a game-player and/or game-team's clock is utilized, the event is logged. This data may or may not be available for analysis, either in real-time, or subsequent to a game's termination. This data may or may not be logged anonymously;
b. The final status of each game-stakeholder clock may be retained with a reference to the individual game-stakeholders each clock belongs to, be retained without a reference to the individual game-stakeholders each clock belonged to, be logged with other game-stakeholder clock usage data for potential future analysis, and/or be discarded.

14. The clock management system of claim 1, wherein game-stakeholders may or may not be associated with internal identifiers and/or external accounts or external information, such that:
a. Each individual game-stakeholder clock may or may not be associated with a possibly unique identifier, assigned and managed by the clock management system. When present, this identifier persists while the player is participating in the game, including during transitions, and may or may not persist upon the stakeholder leaving the game or the game's conclusion. A trace of a game-player's clock activity may persist after they leave the game, even if their individual identifier has been removed. When present, this identifier may or may not be associated with any preexisting player identification;
b. Each game-player or game-team may be associated with one or more external accounts tracked by a game-administrator, may remain anonymous to the clock management system, and/or may have some personal information entered to associate their given game-player clock(s) with or without being associated with an external third-party account.

15. The clock management system of claim 1, wherein the clock-management system may support many types of games, including but not limited to board games, games of chance, sporting games, computer games, and/or video games.

16. The clock management system of claim 1, wherein the clock management system manages any relevant temporal restrictions for collecting prizes associated with results from the game.

17. The clock management system of claim 1, wherein the clock management system allows for any or all data to be provided for analysis, either in real-time or subsequent to a game's termination. This data may or may not be logged anonymously.
